(19) United States
(12) Patent Application Publication
(10) Pub. No.: US 2008/0314820 A1
(43) Pub. Date: Dec. 25, 2008

(54) Permeable Membrane Repelling One or More Liquids

(76) Inventors: Jean-Paul Prulhiere, Bordeaux (FR); Virginie Saavedra, Arcachon (FR)

Correspondence Address: THELEN LLP, P. O. BOX 640640, SAN JOSE, CA, 95164-0640, US

(21) Appl. No.: 12/096,357

(22) PCT Filed: Dec. 4, 2006
(86) PCT No.: PCT/EP2006/069257

§ 371 Date: Jun. 5, 2008

(30) Foreign Application Priority Data
Dec. 6, 2005 (FR) 0553738

(51) Int. Cl. B29C 71/04; B01D 71/00

(52) U.S. Cl. 210/500.22; 210/500.21; 264/400

(57) ABSTRACT

The invention relates to a permeable membrane repelling one or more liquids. The membrane includes at least one face, based on a material repelling said liquids, provided with a plurality of protrusions. The membrane is provided with a plurality of through-holes opening out at said face the protrusions are regularly distributed in a determined way in at least one area on said face. The protrusions also include at least one irregular surface provided with microprotrusions.

### CROSS REFERENCE TO RELATED APPLICATIONS OR PRIORITY CLAIM

This application is a national phase of International Application No. PCT/EP2006/069257, entitled “PERMEABLE MEMBRANE REPELLING ONE OR MORE LIQUIDS”, which was filed on Dec. 4, 2006, and which claims priority of French Patent Application No. 05 53738, filed Dec. 6, 2005.

### DESCRIPTION

The present invention relates to a membrane which is both permeable and repels one or more liquids. This membrane is particularly suitable for separating or extracting non-miscible fluids from each other, for example a gas and a liquid. The present invention also relates to a method for making such a membrane.

### STATE OF THE PRIOR ART

In many industrial fields, it is necessary to separate different fluids which are non-miscible with each other. When the weight and volume constraints are significant, for example when the dimensions of the device which has to achieve this separation, has to be of the order of one millimeter or less, the existing integrated and/or compact devices achieving this separation use passive solutions, such as porous membranes. In the case of a separation of a gas and of a liquid, the size of the pores is such that they prevent the liquid from passing through the membrane, while leaving free passage for the gas. Such membranes may be made with expanded polytetrafluoroethylene (PTFE), utilized for example under the brand Gore-Tex™. The apertures or pores of a membrane used for separating fluids should be of very small dimensions, typically of the order of few nanometers. These dimensions are necessary so that, for example during a separation of a gas and of a liquid, the liquid cannot be discharged through the pores. But this very often causes during the fluid separation process, a saturation of the pores by the liquid, preventing the passage of the gas through the pores. The membrane is therefore no longer permeable and the separation of the gas and of the liquid is then interrupted. Further, the hydrophobic properties of the membrane are generally limited because of the limits of the hydrophobicity of the materials used.

In recent years, by studies conducted by several laboratories on materials repelling liquids, it was possible to obtain surfaces called <<super-hydrophobic >> surfaces. Adherence of the liquids on the surfaces is quasi zero. The term <<super-hydrophobic >> should here be understood as being a strong repulsion for one or more liquids, not necessarily aqueous liquids. These surfaces are presently developed in order to generate materials which maximally repel for example dirt, mist, frost, or further materials on which adherence of liquids is minimum. Two conditions are required for obtaining a super-hydrophobic surface. First of all, the condition of this surface should have some roughness. Indeed, the geometry of a surface considerably plays a role on its hydrophobicity. Certain plant varieties such as ginkgo bilobas, water lilies, or even lotuses, have surfaces, the extremely chiseled features of which give them hydrophobic properties. This kind of features may be reproduced on an artificial surface. But roughness is not sufficient for making a surface super-hydrophobic. The surface also needs to be based on a hydrophobic material. The chemical composition of the plant varieties mentioned earlier naturally gives them this hydrophobic character. For an artificial surface, the surface on which these features are found, may for example be covered with a hydrophobic material. A surface is then obtained which may be described as super-hydrophobic, having properties of hydrophobicity substantially similar to those of the plant varieties mentioned earlier.

The document <<A Super-Hydrophobic and Super-Oleophilic Coating Mesh Film for the Separation of Oil and Water>>, Lin Feng et al., Angewandte Chemie International Edition, Volume 43, Apr. 2, 2004, pages 2012-2014, describes a super-hydrophobic and super-oleophilic membrane with which oil and water may be separated. This membrane includes a support in the form of a grid based on stainless steel. This grid is covered with a hydrophobic and oleophilic material, forming on the support, protrusions as elementary beads or blocks formed by assemblies of beads, aggregated with each other. This material is spread out and then dried. These protrusions are therefore distributed randomly over the surface of the grid. The dimensions of the protrusions formed are therefore also random. When oil drops are projected onto the membrane, the latter may pass through it, unlike water drops which are retained by the membrane through the hydrophobic properties of the material covering the grid. However, the random distribution of the protrusions may cause actual random hydrophobicity. If, for example, an area of the membrane only includes a few protrusions, hydrophobicity of this area will then be low. This distribution of the hydrophobic power of the membrane may therefore be random. Further, as the distribution of the material covering the grid may not be uniform because of the method used (spraying), clusters may form at the holes. Some holes will therefore have too small dimensions in order to properly let through the oil and may fill up as this is the case for porous membranes.

### DISCUSSION OF THE INVENTION

The object of the present invention is to propose a membrane repelling one or more liquids and which is permeable, as are the membranes from the prior art, but the permeability of which remains constant throughout the use of the membrane and the hydrophobicity of which is not random.

To achieve these goals, the present invention proposes a permeable membrane repelling one or more liquids having at least one face, based on a material repelling said liquids, provided with a plurality of protrusions, the membrane being provided with a plurality of through-holes opening out at said face, the protrusions being regularly distributed in at least one area on said face.

Thus, instead of using a porous membrane, the permeability of which is not guaranteed for example during separation of a gas and of a liquid, a membrane is used for which permeability is achieved by a plurality of holes passing entirely through the membrane. This membrane includes a face provided with a plurality of protrusions and based on a material repelling one or more liquids, for example forming a super-hydrophobic surface if the repelled liquid is water or an aqueous solution. With this super-hydrophobic surface, permeability of the membrane may be guaranteed throughout its use by preventing, for example during the separation of a gas and of a liquid, the liquid from filling up the holes through which the gas has to be discharged. Further, by the regular distribution of the protrusions, it is possible to make membranes for which the permeability and repelling power of the membrane are characterized very specifically by controlling the position of the protrusions on the face of the membrane.

In the area of the face provided with protrusions, neighboring protrusions may have substantially similar shape and dimensions.

The holes may be regularly distributed in the membrane.

The protrusions may be spikes, for example with a substantially cylindrical shape, such as a straight cylinder or a parallelepiped, or a conical shape such as a truncated pyramid or a truncated straight cone, or ribs.

The protrusions may form a regular array of lines and/or columns.

The protrusions may each have a platform apex in order to further increase the repelling power of the membrane.

The holes may substantially open out into recesses formed between the protrusions, or at the apices of the protrusions.

The membrane may be made on the basis of at least one material repelling said liquids.

The membrane may include a support provided with a face covered with a material repelling said liquid, said face of the support being the face of the membrane which includes the protrusions. Thus, it is not necessary that the whole of the membrane be based on a material repelling said liquids.

The membrane may for example be hydrophobic and/or oleophobic. Thus, the repelled liquids may be aqueous liquids and/or based on oil or a hydrocarbon.

Further, the membrane may be hydrophobic and oleophilic, or oleophobic and hydrophilic. In this configuration, the membrane may achieve discrimination between an aqueous liquid and a liquid based on oil or a hydrocarbon.

The protrusions may include at least one irregular surface provided with microprotrusions, thereby increasing the repelling power of the membrane towards liquids.

The object of the invention is also a method for making a membrane according to the invention, including the following steps:

making on at least one face repelling said liquids, a support, a plurality of protrusions regularly distributed in at least one area on said face,

making a plurality of through-holes opening out at said face.

The plurality of protrusions may be made by molding or chemical or laser etching.

The method may include an additional step for depositing on the face of the support including the protrusions, a layer of a material repelling said liquids.

The method may also include an additional step for making microprotrusions on the face including the protrusions.

The microprotrusions may be made by chemical etching.

### BRIEF DESCRIPTION OF DRAWINGS

The present invention will be better understood upon reading the description of exemplary embodiments given purely as an indication and by no means as a limitation, with reference to the appended drawings wherein:

FIG. 1 illustrates a permeable membrane repelling one or more liquids, object of the present invention, according to a first embodiment;

FIG. 2 illustrates a permeable membrane repelling one or more liquids, object of the present invention, according to a second embodiment;

FIG. 3 illustrates a permeable membrane repelling one or more liquids, object of the present invention, according to a third embodiment.

Identical, similar or equivalent portions of the different figures described hereafter bear the same numerical references so as to facilitate passing from one figure to the other.

The different portions illustrated in the figures are not necessarily according to a uniform scale, so as to make the figures more legible.

The various possibilities (alternatives and embodiments) have to be understood as not being exclusive with each other, and may be combined with each other.

### DETAILED DESCRIPTION OF PARTICULAR EMBODIMENTS

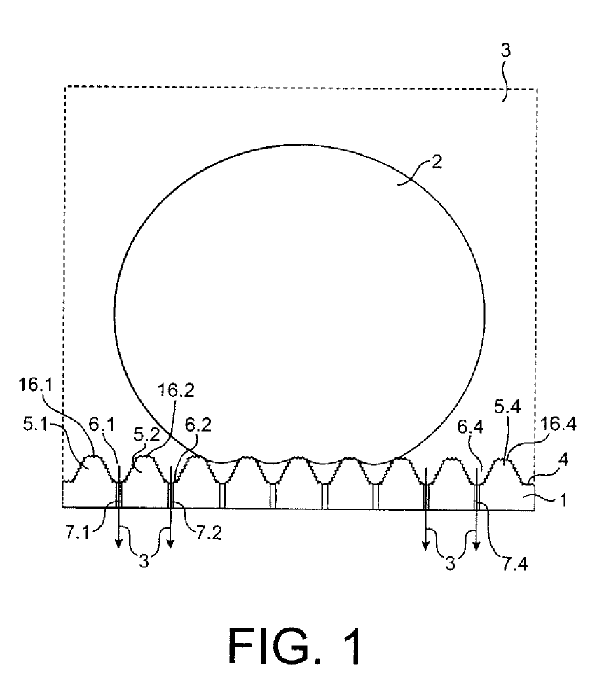

Reference will first of all be made to FIG. 1 which illustrates a permeable membrane 1 repelling one or more liquids according to a first embodiment. The membrane 1 is intended to separate two liquids or a gas and a liquid which are non-miscible with each other and of different nature. Here, the membrane 1 is intended to separate a liquid 2 forming a drop and a gas 3 surrounding the liquid drop 2. The liquid 2 will be the liquid repelled by the membrane 1. In this first embodiment, the membrane 1 is for example hydrophobic. Therefore, the liquid 2 is for example an aqueous liquid. A membrane 1 may also be made which is oleophobic, thereby repelling oil-based liquids, or even which would repel liquids which are neither based neither on water nor on oil, such as for example alcohols or ether. In this first embodiment, the membrane 1 is made on the basis of a hydrophobic material. This material may for example be based on heptadecafluorodecyltrichlorosilane, on perfluorooctyl-trichlorosilane, heptadecafluorodecyltrimethoxysilane, perfluorododecyltrichlorosilane, fluoropolymer, fluorinated polyvinyl, polyperfluoroalkyl acrylate, alkylketene, fluorinated graphite, or further monoalkyl phosphate.

The membrane 1 includes at least one face 4 provided with a plurality of protrusions 5.1-5.n. The protrusions 5.1-5.n are regularly distributed over the face 4. In the first embodiment, the protrusions 5.1-5.n are made as spikes for example. Here, the spikes 5.1-5.n form a regular array of lines and columns. In FIG. 1, each spike has a conical shape, for example a truncated pyramidal or truncated straight conical shape. But these spikes may have a different shape, for example a cylindrical shape such as a straight cylinder or a parallelepiped. In this first embodiment, the height of the spikes 5.1-5.n is about a few micrometers. The protrusions 5.1-5.n may also have a shape other than spikes, such as for example ribs. Here, an apex 16.1-16.n of each of the spikes 5.1-5.n forms a platform. In FIG. 1, the protrusions 5.1-5.n are regularly spaced out so as to form recesses 6.1-6.n between them. Further, in this first embodiment, the protrusions 5.1-5.n have substantially similar shape and dimensions. The protrusions 5.1-5.n, when the liquid drop 2 will be in contact with the face 4, will allow the contact surface or the adherence to be reduced between the face 4 of the membrane 1 and the liquid drop 2. Thus, by making a face 4 which is both rough, the roughness of which being obtained by the protrusions 5.1-5.n, and based on a hydrophobic material, a membrane 1 is obtained for which the face 4 may be described as super-hydrophobic, i.e. here having very strong hydrophobicity. Further, by the fact that this roughness is regular through the uniformity of the protrusions 5.1-5.n and their regular distribution, it is guaranteed that the repelling power of the membrane 1 is uniform over the whole of the face 4 of the membrane 1.

The protrusions 5.1-5.n may be made by chemical or laser etching, for example. It may also be of interest to make the protrusions 5.1-5.n of the membrane 1 by molding. For this, a die inversely reproducing the features of the face 4 is first of all made. This die is then applied by pressing it on a support, then forming the protrusions on the support. With this technique, the membranes 1, objects of the present invention, may be made in a not very expensive way and a large number of membranes 1 may be made.

The membrane 1 also includes a plurality of holes 7.1-7.n entirely passing through the membrane 1. The holes 7.1-7.n open out at the face 4 of the membrane 1. More specifically, in this first embodiment, the holes 7.1-7.n open out at the recesses 6.1-6.n of the membrane 1, i.e. between the protrusions 5.1-5.n. Thus, the holes 7.1-7.n are also regularly distributed in the membrane 1. Thus, the holes 7.1-7.n of the membrane 1 may be regular and uniform because with the techniques used for their making, such as etching, it is possible to entirely control their shapes and their dimensions.

The membrane 1 of FIG. 1 is used for separating the gas 3 from the liquid 2. In FIG. 1, the drop of liquid 2 is on the face 4 of the membrane 1. As the face 4 of the membrane 1 is super-hydrophobic, the drop of liquid 2 remains <<laid >> on the platform apices 16.1-6.n of the protrusions 5.1-5.n and does not come into contact with the face 4 at the recesses 6.1-6.n. The liquid 2 therefore cannot pass through the membrane 1 through the holes 7.1-7.n. Adherence of the drop of liquid 2 on the face 4 depends on the hydrophobicity power of the material used for making the membrane 1, on the distribution of the protrusions 5.1-5.n on the face 4, and on the geometry of the protrusions 5.1-5.n. This geometry is characterized by the shape of the protrusions 5.1-5.n, but also by the dimensions of the protrusions 5.1-5.n. Certain constraints are taken into account for making the protrusions 5.1-5.n. For example in the case of protrusions 5.1-5.n as spikes, as this is the case in FIG. 1, the protrusions 5.1-5.n are preferably not too spaced out from each other and the platform apices 16.1-16.n of the protrusions 5.1-5.n have sufficient surface area because the drop of liquid 2 otherwise risks penetrating into the recesses 6.1-6.n. The height of the protrusions 5.1-5.n is sufficient so that the drop of liquid 2, which is slightly deformed at the recesses 6.1-6.n between two protrusions because of the weight of the liquid 2, will not touch the surface of the face 4 at the bottom of the recesses 6.1-6.n because the liquid 2 would risk blocking the holes 7.1-7.n of the membrane 1 which open out at the recesses 6.1-6.n. Thus, the gas 3 which surrounds the drop of liquid 2 in FIG. 1, on the side of face 4, may be separated from the liquid 2 by passing through the membrane 1 through the holes 7.1-7.n. The discharge of the gas 3 through the holes 7.1-7.n is illustrated by arrows in FIG. 1. The discharge rate of the gas 3 may be controlled by means of the number of holes 7.1-7.n made in the membrane 1, but also by the specific dimensions of these holes 7.1-7.n.

The membrane 1 may also not be used for separating the liquid 2 and the gas 3, but also for bringing them together. The gas 3, which would then be found on the side of a face of the membrane 1 opposite to the face 4, may then pass through the membrane 1 through the holes 7.1-7.n in order to end up on the side of the face 4 where the liquid 2 is found, without the liquid 2 blocking the holes 7.1-7.n.

The protrusions 5.1-5.n include an irregular surface 4. These irregularities made on the surface 4 of the membrane 1 are microprotrusions. These microprotrusions 17 may be made for example by chemical etching. These microprotrusions 17 may have dimensions, such as their height and/or their width, of the order of about a few nanometers, for example comprised between about 1 and 10 nanometers or further comprised between about 10 and 100 nanometers, or even comprised between about 100 nanometers and 1 micrometer, and be of a different shape and/or size from each other. By means of these microprotrusions 17, the hydrophobic power of the membrane 1 is increased as compared with a membrane not including microprotrusions.

It is also possible to vary the hydrophobic power of the membrane 1 by for example applying an electrical voltage between the liquid 2 and the membrane 1. The hydrophobic power of the membrane 1 relatively to the nature of the liquid 2 may thereby be electrically controlled and adapted at best.

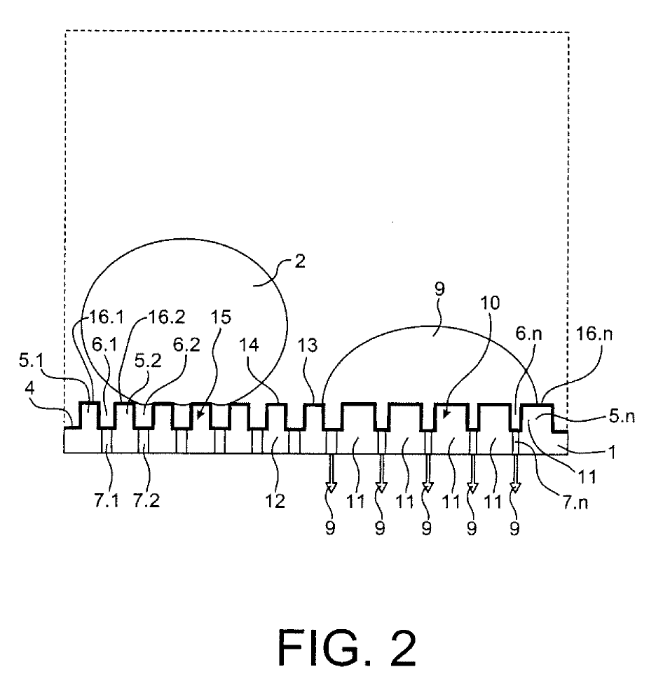

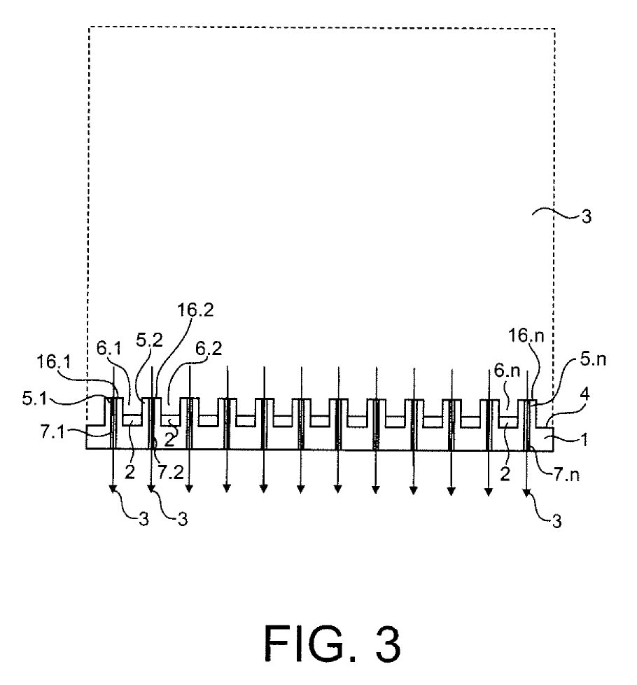

Now reference is made to FIG. 2 which illustrates a membrane 1 according to a second embodiment. As compared with the membrane 1 of FIG. 1, the membrane 1 of FIG. 2 includes a support 12 made on the basis of any material, for example based on a semiconductor such as silicon, provided with a face 13 covered with a material 14 repelling one or more liquids, said face 13 of the support 12 being the face 4 of the membrane 1 which includes the protrusions 5.1-5.n. The material 14 covering the support 12 is a both hydrophobic and oleophilic material, for example. The protrusions 5.1-5.n may also include microprotrusions, not illustrated in FIG. 2, for example similar to the microprotrusions 17 of FIG. 1, made on the face 13. These microprotrusions may then be covered by the material 14, conforming to the profile of these microprotrusions. Here, the protrusions 5.1-5.n are regularly distributed in two areas 10 and 15, each area including protrusions 5.1-5.n substantially identical with each other. In FIG. 2, the protrusions found in the area 10 have a wider base than that of the protrusions found in the area 15. This membrane 1 according to the second embodiment is intended to be used for achieving separation of two liquids of different natures, such as a first liquid 2 for example based on water, and a second liquid 9 for example based on oil. As in FIG. 1, the holes 7.1-7.n open out into the recesses 6.1-6.n formed between the protrusions 5.1-5.n. When a drop of the first liquid 2 is in contact with the face 4 of the membrane 1, as this is illustrated in FIG. 3, this drop remains <<laid >> on the platform apices 16.1-16.n of the protrusions 5.1-5.n through the hydrophobic properties of the material 14 covering the face 13 of the support 12 and through the protrusions 5.1-5.n. The first liquid 2 cannot therefore pass through the membrane 1. When a drop of the second liquid 9 is in contact with the face 4 of the membrane 1, given that the material 14 covering the face 13 of the support 12 is oleophilic, the drop of the second liquid 9 will come into contact as much as possible with the face 4 of the membrane 1 through the affinity of the material 14 for the liquid 9. The drop of the second liquid 9 will therefore spread out on the protrusions 5.1-5.n but also penetrate into the recesses 6.1-6.n. Thus, the second liquid 9 may pass through the membrane 1 by passing through the holes 7.1-7.n, unlike the first liquid 2. In another configuration, the first liquid 2 based on water may also be intended to pass through the membrane 1 through the holes 7.1-7.n, but not the second liquid 9 based on oil. In this case, the face 13 of the support 12 is covered with a material 14 which is both oleophobic and hydrophilic.

Now reference is made to FIG. 3 which illustrates a membrane 1 according to a third embodiment. The membrane 1 of FIG. 3 is made on the basis of hydrophobic material, such as one of those mentioned earlier. Unlike the membranes 1 of both previous embodiments, the holes 7.1-7.n of the membrane 1 according to the third embodiment do not open out at the recesses 6.1-6.n, but at the platform apices 16.1-16.n of the protrusions 5.1-5.n. There again, the protrusions 5.1-5.n may include microprotrusions, not illustrated in this FIG. 3, for example similar to the microprotrusions illustrated in FIG. 1. This membrane 1 is intended to separate a gas 3 from a liquid 2, as in the first embodiment. However, this membrane 1 is intended to be used when the amount of liquid 2 is very small. Indeed, in this case, the liquid 2 does not form drops as in FIGS. 1 and 2, but a fine film which will be deposited in the recesses 6.1-6.n. The liquid 2 therefore remains trapped in the membrane 20, in the recesses 6.1-6.n, without reaching the holes 7.1-7.n. Given that the holes 7.1-7.n being at the apices 16.1-16.n of the protrusions 5.1-5.n are not blocked by the liquid 2, the gas 3 may be discharged through the holes 7.1-7.n and thereby be separated from the liquid 2. In FIG. 4, the discharge of the gas 3 is illustrated by arrows.

Although several embodiments of the present invention have been described in detail, it will be understood that different changes and modifications may be made thereto without departing from the scope of the invention.

1. A permeable membrane repelling one or more liquids, having at least one face based on a material repelling said liquids, provided with a plurality of protrusions, the membrane being provided with a plurality of through-holes opening out at said face, the protrusions being regularly distributed in a determined way in at least one area on said face, and the protrusions including at least one irregular surface provided with microprotrusions.

2. The membrane according to claim 1, including in the area of the face provided with protrusions, neighboring protrusions having substantially similar shape and dimensions.

3. The membrane according to claim 1, wherein the holes are regularly distributed in the membrane.

4. The membrane according to claim 1, wherein the protrusions are spikes.

5. The membrane according to claim 4, wherein the spikes have a substantially cylindrical shape, such as a straight cylinder or a parallelepiped or a conical shape such as a truncated pyramid or truncated straight cone.

6. The membrane according to claim 1, wherein the protrusions are ribs.

7. The membrane according to claim 1, wherein the protrusions form a regular array of lines and/or columns.

8. The membrane according to claim 1, wherein the protrusions each have a platform apex.

9. The membrane according to claim 1, wherein the holes substantially open out into recesses formed between the protrusions.

10. The membrane according to claim 1, wherein the holes substantially open out at the apex of the protrusions.

11. The membrane according to claim 1, said membrane being made on the basis of at least one material repelling said liquids.

12. The membrane according to claim 1, including a support provided with a face covered with a material repelling said liquids, said face of the support being the face of the membrane which includes the protrusions.

13. The membrane according to claim 1, said membrane being hydrophobic and/or oleophobic.

14. The membrane according to claim 13, said membrane being hydrophobic and oleophilic, or oleophobic and hydrophilic.

15. A method for making a membrane according to claim 1, including the following steps:
making on at least one face repelling said liquids, a support, a plurality of protrusions regularly distributed in at least one area on said face,
making a plurality of through-holes opening out at said face,
making microprotrusions on the face including the protrusions.

16. The method according to claim 15, the plurality of protrusions being made by molding or chemical or laser etching.

17. The method according to claim 15, including an additional step for depositing onto the face of the support including the protrusions, a layer of a material repelling said liquids.

18. The method according to claim 15, the microprotrusions being made by chemical etching.
